(19) United States
(12) Patent Application Publication
(10) Pub. No.: US 2006/0135652 A1
(43) Pub. Date: Jun. 22, 2006

(54) Method for preparing ziconia ceramics using hybrid composites as precursor materials shaped by CAD/CAM process

(75) Inventors: Abdeslam Kasseh, Ile Bizard (CA); Elmekki Ennajimi, Dollard-des-Ormeaux (CA); Jamal Chaouki, Dorval (CA)

Correspondence Address: Medin Tech, 6644 Abrams, St. Laurent, QC, H4S 1Y1, CA

(73) Assignee: FORMMAT TECHNOLOGIES INC., Montreal (CA)

(21) Appl. No.: 11/014,979

(22) Filed: Dec. 20, 2004

(51) Int. Cl. C08K 9/00

(52) U.S. Cl. 523/205

(57) ABSTRACT

This invention is a novel method for making zirconia ceramic from hybrid composite biomaterials. The inorganic particles of zirconium oxide with a desired size and controlled shape were synthesized in an alcohol solution in the presence of water and a morphologic catalyst. Zirconium alkoxides and/or zirconium oxychloride, Yttrium alkoxide, Yttrium nitrate hexahydrate and Yttrium chloride, were used as the precursor materials for the preparation of zirconium oxide colloidal suspensions. Particle surface modification by the introduction of polymerization precursors was carried out in colloidal suspension. Highly-filled and well dispersed composite biomaterials with thermoplastic and/or thermo-hardening matrices are easily obtained using several polymerization techniques, like catalytic polymerization, controlled free radical polymerization, and polycondensation. This new method makes it possible to prepare composite biomaterials with monodispersed and spherical colloidal particles that are well dispersed and highly compacted in the polymeric matrix and with an easy control of the number of grafted polymeric chains per particle. The obtained biomaterials have the advantage of being sintered isotropically with a weak and controlled shrinkage. These properties offer the possibility of shaping these materials using CAD/CAM technology in the composite state followed by a sintering process leading to TZP (tetragonal zirconia polycrystal) ceramic.

### REFERENCES CITED [REFERENCED BY]

U.S. Patent Documents

| | | | |
|---|---|---|---|
| 4520114 | May 1985 | Lawrence | 501/12 |
| 3442817 | May 1969 | Donald V | 516/90 |

Foreign Patent Documents

| | | |
|---|---|---|
| EP0267449 | May 1988 | Maurice |
| FR2661171 | October 1991 | Duchet |
| EP0251537 | June 1988 | Allen |

### OTHER REFERENCES

K. S. Mazdiyansi, C. T. Lynch, J. S. Smith, J. Amer. Cer. Soc. 48, 372-375 (1965), J. Amer. Cer. Soc. 50, 532-537 (1967)

### BACKGROUND OF THE INVENTION

1. Field of the Invention

The present invention is concerned with methods of synthesizing highly pure tetragonal zirconia polycrystal (TZP) using highly filled composite biomaterials, which consist of a combination of monodispersed zirconium oxide/Yttrium oxide spherical particles with a controlled size and polymeric matrix chemically and covalently compounded to zirconium oxide surfaces. The high mechanical and thermal properties of tetragonal zirconia polycrystal lead to its use in applications requiring high temperature, high strength, toughness and brightness. The purity of TZP is an important parameter in medical and electronic applications. In particular, pure TZP is useful for orthopedic, dentistry, and structural and electronic packaging. These composites are used as precursors for ceramics and are easily machined using the CAD/CAM process before sintering.

2. Background art

Tetragonal zirconia polycrystal is a ceramic material, which exhibits higher mechanical and thermal properties. The significant potential of its use in applications, such as refractories, engineering ceramics, thermal barrier coatings, orthopedics, dentistry, electronics and aerospace has attracted much interest. In consequence, several methods of synthesis and preparation have been carried out in order to improve the conventional procedures. The properties of the final zirconia depend on the properties of the green body. In particular, it depends on particle size distribution, particle shape and agglomeration. A small particle, large specific surface area, and desired particle size distribution will greatly enhance the sintering kinetics, such as a shorter sintering time, lower sintering temperature, and denser gravity of the sintered body.

There are chemical methods of producing tetragonal zirconia polycrystal, such as coprecipitation of the zirconia and its stabilizing oxide from an aqueous chloride solution, followed by calcination from 500° to 1000° C. Hydrothermal treatment of zircon or zirconyl chloride gives high pure zirconia.

E.P. 0267449 describes methods of synthesizing high purity, partially tetragonal zirconia or filly stabilized cubic zirconia from aqueous solutions or suspensions using a metal salt of a hydroxycarboxylic acid of the desired stabilizing metal oxide combined with zirconium salt or zirconyl salt of a hydroxycarboxylic acid as the precursor materials.

F.R. 2661171 describes a process for the synthesis of stabilized zirconia by the impregnation of amorphous zirconia grains with a stabilizing metal followed by calcination. The stabilized zirconia is used as a catalyst in the conversion of hydrocarbons.

E.P. 0251537 describes a process for the preparation of the mixture of zirconia and another metal oxide from a zirconium salt and another metal salt. More particularly, the invention relates to the preparation of such zirconium mixtures by controlled precipitation through which impurities that may inhere in the starting zirconium salt are excluded from the zirconium product, and through which a substantially homogenous mixture is provided.

U.S. Pat. No. 4,520,114 describes a process for producing a fine grain metastable tetragonal zirconia, which has an average particle size less than about 1000 angstroms in diameter. The process involves multistage thermolysis of precursor solids comprising a homogeneous mixture of β-ketonate compounds of zirconium and a stabilizer metal, such as yttrium.

U.S. Pat. No. 3,442,817 describes the preparation of zirconia sols by heating an aqueous solution of zirconyl acetate to a temperature of 175° to 400° C. to form colloidal particles and putting the resulting suspension in contact with a cation exchange resin to remove free zirconyl ions.

Hydrolysis of metal alkoxides to form tetragonal and cubic zirconia was demonstrated by Mazdiyasni and his coworkers, K. S. Mazdiyansi, C. T. Lynch, J. S. Smith, J. Amer. Cer. Soc. 48, 372-375 (1965), J. Amer. Cer. Soc. 50, 532-537 (1967).

It was also demonstrated that the hydrolysis behavior of zirconium alkoxide differs from that of silicon, aluminium and titanium alkoxides. The water-alkoxide ratio strongly influences the shape and size of the particles and, consequently, the sintering and crystallization behavior of zirconia powders.

### SUMMARY OF THE INVENTION

The present invention provides a process for the synthesis of tetragonal zirconia polycrystal with a specific shape using composite biomaterials as precursors. These materials are shaped easily at a specific geometry at the composite state using the CAD/CAM process. These composites are highly filled with zirconium oxide/Yttrium oxide, at least 85 wt % dispersed in the polymeric matrix. Zirconium oxide particles were synthesized by using zirconium alkoxide and/or zirconium oxychloride in a mixture of alcohol/water solvent containing a base as morphologic catalyst. By controlling the water/zirconium alkoxide and base/water ratios, densified zirconium oxide/Yttrium oxide particles with a controlled spherical shape and size are obtained. Further controlling the shape and size of synthesized zirconium oxide/yttrium oxide particles, using a controlled sol-gel process, the medium also permits grafting vinyl groups, initiators and/or catalyst, as precursors for polymerization compounding. The latter approach permits the growing of grafted chains from the surface in situ by avoiding bulk polymerization, and controlling the number and length of grafted chains per particle. In this way, highly filled and homogeneous composites with a much lower amount of organic matter can be prepared. The required properties of an idealized sinterable material for producing a uniform, fully dense, and single phase ceramic consist of a fine size, narrow size distribution, an equiaxed shape, a non agglomerate state and high purity. In this way, particle-size distribution is very important to achieve maximum particle packing and uniformity so that minimum shrinkage and retained porosity will result during densification. Ceramic particles are generally irregular in shape and do not fit into an ideal packing of spheres. So it is desirable to control particle shape and particle-size distribution. The reactivity of zirconium oxide particles is related to their size and surface area. Small particles with higher specific surface area have a tendency to reduce their surface area by inter-particular condensation between hydroxyl groups during the sintering process leading to ceramic material with a density near to the theoretical value at a lower time and temperature.

Colloidal suspension of zirconium oxide with controlled size and shape can be obtained in a solution mixture of alcohol/water and a base catalyst. Zirconium oxide was prepared by controlled hydrolysis of zirconium alkoxide and/or zirconium oxychloride in the presence of a base, such as morphologic catalyst. The final particle size can be estimated from the initial concentrations of the reactants. Afterward the alcosol particles can be grown further to the desired radius by the controlled addition of zirconium alkoxide and/or zirconium oxychloride.

### EXAMPLE 1

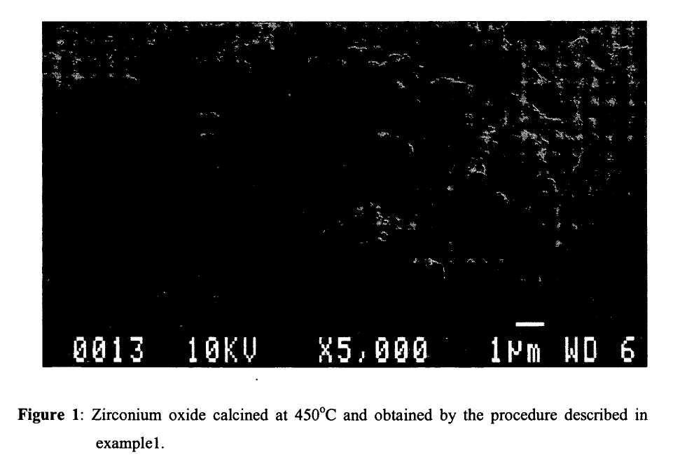

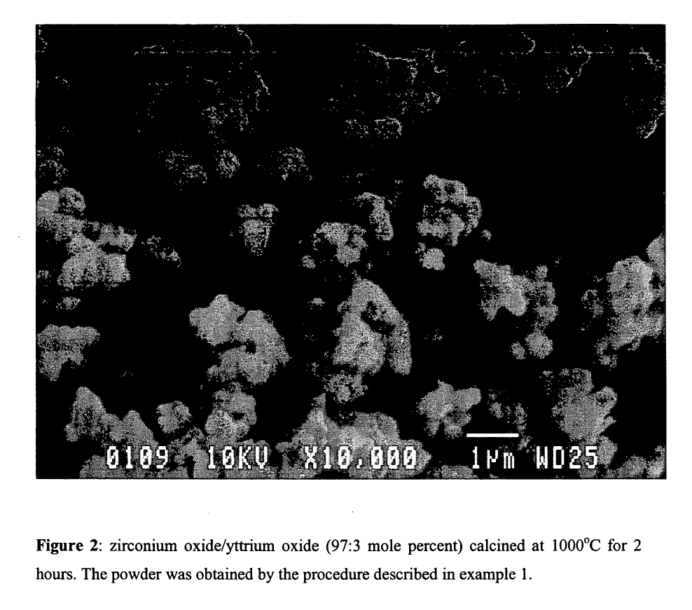

Alcosol was prepared in mixture of ethanol, water and ammonia. Zirconium n-propoxide and yttrium nitrate hexahydrate were added to the alcosol and the mixture was stirred at ambient temperature. After washing and drying the produced powder under vacuum, the calcination was carried out between 400 and 1000° C. An example of nanopowder obtained by this procedure and calcined at 450° C. are given in FIGS. 1 and 2.

Vinyl groups were grafted on the surface of spherical particles in the same medium as precursors for polymerization compounding. 3-methacryloxypropyltrimethoxysilane (TPM) is used as a functionalized coupling agent, because it reacts easily with hydroxyl groups onto zirconium oxide/yttrium oxide surfaces under mild conditions. A TPM was added to the mixture and stirred at room temperature. Then, a part of the solvent was removed by distillation under vacuum. The modified particles were extracted and dried under vacuum. Zirconium oxide/Yttrium oxide powder (97:3 mole percent or 92:8 mole percent) was dispersed in di-methacrylic monomers in the presence of AIBN initiator (1 wt % of monomers weight). The composites were then compacted and shaped in a specific mold leading by in situ polymerization for a few hours at specific temperature to the final composite.

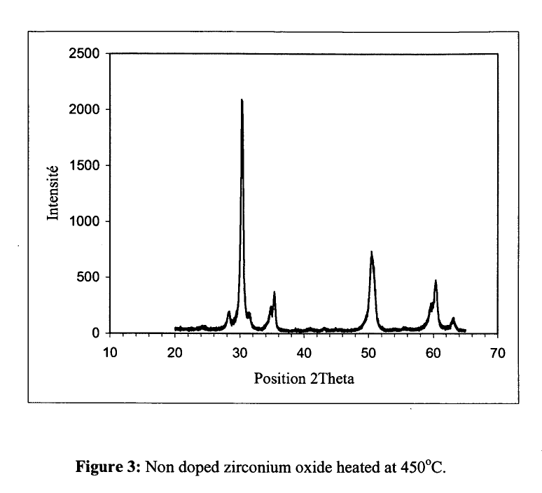

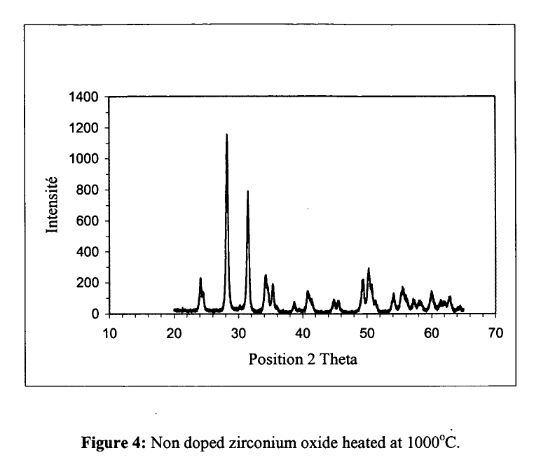

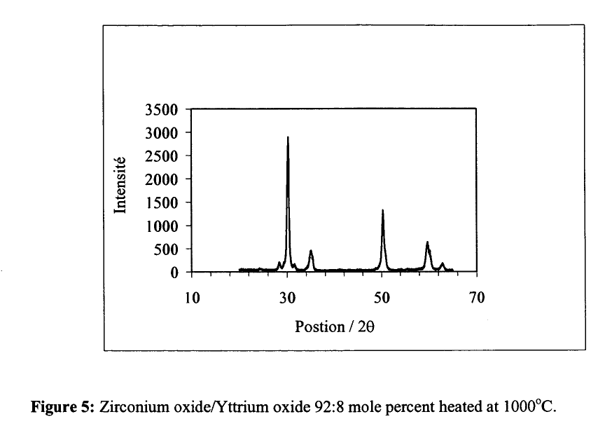

Non-doped zirconia heated at 450° C. for 5 hours presents a tetragonal phase as a crystal structure (see FIG. 3). The same powder when heated at 1000° C. for at least 2 hours gives a monoclinic phase (FIG. 4). However, doped zirconia with yttrium oxide at 3 and 8 mole percent gives a tetragonal phase when they are heated at 1000° C. for at least 2 hours (see FIG. 5). Doped powder treated at 1000° C. has a density equal to 5.9 g/cm³.

Composites of zirconium oxide/yttrium oxide dispersed in a thermo-hardening matrix (Bis-GMA/TEDGMA) have a weight fraction oxide/polymer ranging from about 95:5 to about 85:15. These composites exhibit a density comprised between 2.4 and 3.8 g/cm³.

The compression moduli of composites were measured using the Instron 8821S instrument. The compression tests were carried out at 21° C., the humidity was about 49%, and the speed was about 1 mm/min. Each sample has been tested three times. The results are given in the table below:

| | Modulus | Max load | Strain at | Load at break | Strain at |
|---|---|---|---|---|---|
| sample | (MPa) | (N) | Max. Load | (N) | break |
| 1 | 5553.8 | 24940.24 | 0.0226 | — | — |
| 2 | 5775.59 | 24988.53 | 0.0219 | — | — |
| 3 | 5673.58 | 24985.73 | 0.0216 | — | — |
| Mean | 5667.66 | 24971.50 | 0.0220 | — | — |

The sample does not break even at the maximum charge that can be applied by the instrument. The process comprises a net shape part. The ingots can be produced in a cylindrical mold by in situ polymerization or shaped in a specific form by using CAD/CAM processing at the composite state. The process also comprises a second step of sintering the ingots and/or machined pieces obtained by the CAD/CAM process. The composite is sintered by sequentially:
(a) Heating the composite pieces from room temperature at a heating ramp ranging from about 0.2° C./min to about 0.5° C./min to a temperature in the range of about 400° C. to 500° C.
(b) Maintaining the temperature constant at a temperature ranging from about 400° C. to about 500° C. for about 1 to 5 min.
(c) Heating the composites pieces from a temperature ranging from about 400° C. to about 500° C. to a temperature in the range of about 1300° C. to 1700° C. at a heating ramp ranging from 1.5° C. to 2.0° C.
(d) Maintaining the temperature constant at a temperature in the range of about 1300° C. to about 1700° C. for about 2 to 5 hours.
(e) Cooling the sintered piece from a temperature in the range of about 1300° C. to 1700° C. to a temperature ranging from about 100° C. to a room temperature at a heating ramp in the range of 1.5
(f) 1.6° C. to 3.0° C.

Sintering Results:

The sintering process was carried out on cylindrical ingots compressed at 200 MPa.

| sample | V (cm³) | Weight (g) | Density (g/cm³) |
|---|---|---|---|
| 1 | 2.212126 | 13.406 | 6.0602 |
| 2 | 2.154175 | 13.022 | 6.0450 |
| 3 | 2.074243 | 12.549 | 6.0499 |

The shrinkage is isotropic. A dimensional shrinkage, from composite part to ceramic, is of less than 0.001 percent.

The density of the obtained pieces is comprised between 6 and 6.1 g/cm³.

Specific Surface Area:

| Temperature (° C.) | Surface area (m²/g) |
|---|---|
| 120 | 264 |
| 450 | 12.78 |
| 1000 | 6 |

Elemental Analysis

| ZrO₂ calcined at | Carbon | Nitrogen | Hydrogen | Sulphur |
|---|---|---|---|---|
| 450 or 1000° C. | (%) | (%) | (%) | (%) |
| sample1 | 0 | 0 | 0 | 0 |
| Sample 2 | 0 | 0 | 0 | 0 |

| | Mean | Dev. Std | S.D rel (%) | Variance |
|---|---|---|---|---|
| Carbon (%) | 0 | 0 | 0 | 0 |
| Nitrogen (%) | 0 | 0 | 0 | 0 |
| Hydrogen (%) | 0 | 0 | 0 | 0 |
| Sulphur | 0 | 0 | 0 | 0 |

### EXAMPLE 2

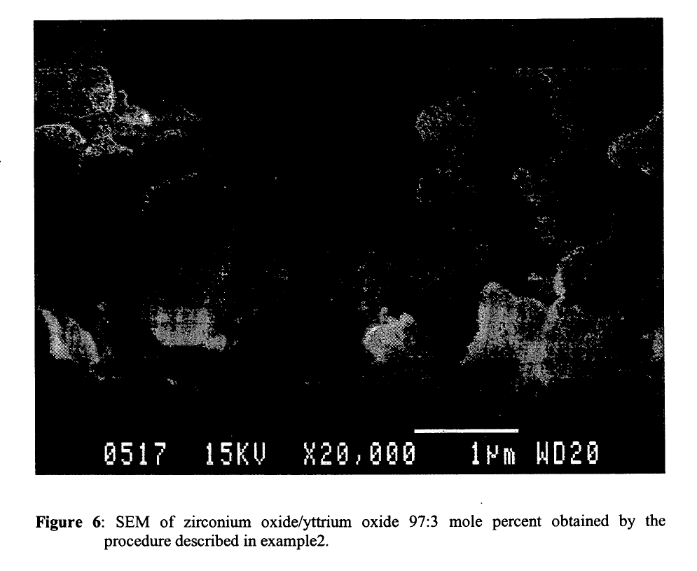

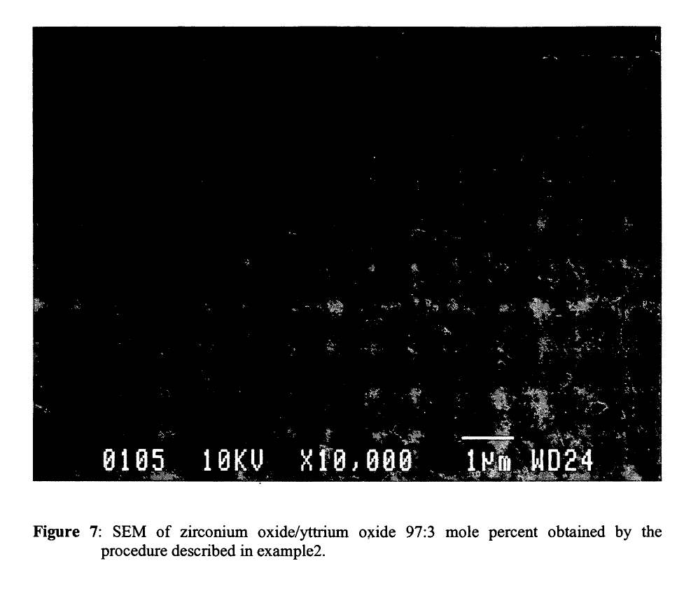

Alcosol was prepared in a mixture of ethanol, water and ammonia. An aqueous solution of zirconium oxychloride (ZrOCl₂.8H₂O) and yttrium nitrate hexahydrate was added to the mixture under stirring. The mixture was stirred for 4 hours leading to zirconium oxide sol. After that we introduced sodium hydroxide as a base until reaching a solution having a pH between 8 and 12. Afterward the produced powder was washed with an excess of water until neutralizing the pH of the solution. This powder was dried at 130° C. The powder was also calcined at 450° C. for 2 hours, at 1000° C. for 2 hours, and at 1200° C. for 2 hours. The micrographs of the powder obtained by scanning electron microscopy were given in FIGS. 6 and 7.

Vinyl groups were grafted on the surface of spherical particles in the same medium as precursors for polymerization compounding. 3-methacryloxypropyltrimethoxysilane (TPM) is used as a functionalized coupling agent, because it reacts easily with hydroxyl groups onto the zirconium oxide surface under mild conditions. A TPM was added to the mixture and stirred at room temperature. Then, a part of the solvent was removed by distillation under vacuum. The modified particles were extracted and dried under vacuum. Zirconium oxide/Yttrium oxide powder (97:3 in mol %) was dispersed in di-methacrylic monomers in the presence of AIBN initiator (1 wt % of monomers weight). The composites were then compacted and shaped in a specific mold leading by in situ polymerization for a few minutes at a specific temperature to the final composite.

Doped powder treated at a temperature in the range of about 450° C. to about 1000° C. has a density in the range of about 5.6 g/cm³ to about 5.9 g/cm³.

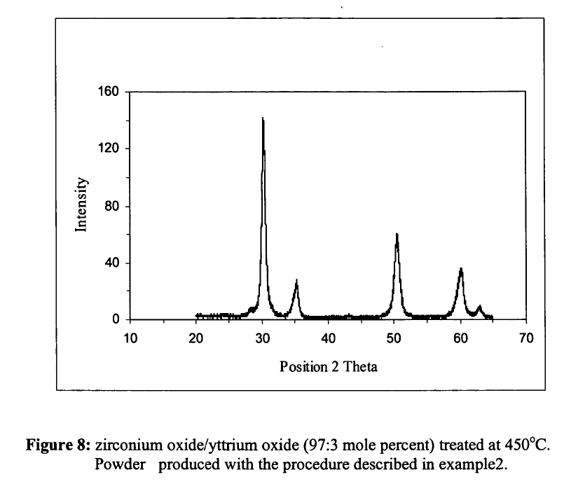

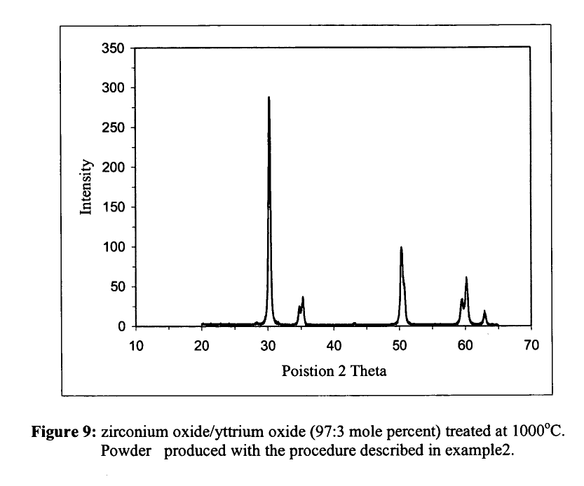

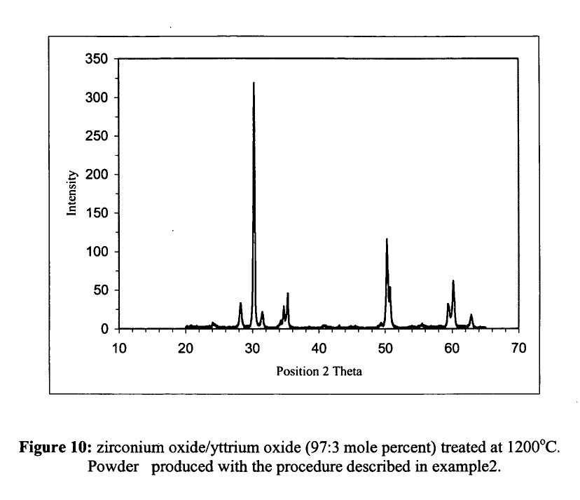

Doped powder zirconium oxide/Yttrium oxide 92:8 mole % treated at a temperature of about 450° C., 1000° C. and 1200° C. gives a tetragonal phase, respectively (see FIGS. 8, 9 and 10).

Composites with a weight fraction of the thermo-hardening matrix ranging from about 5 to 15 have a density in the range of about 2.5 g/cm³ to 3.8 g/cm³.

Theses composites were machined using the CAD/CAM process to a specific shape and these specific pieces are sintered using the process described above.

The compression moduli of composites were measured using the Instron 8821S instrument. The compression tests were carried out at 21° C., the humidity was about 49%, and the speed was about 1 mm/min. Each sample has been tested three times. The results are given in the table below:

| | Modulus | Max load | Strain at | Load at break | Strain at |
|---|---|---|---|---|---|
| sample | (MPa) | (N) | Max. Load | (N) | break |
| 1 | 4317.01 | 24963.40 | 0.0288 | — | — |
| 2 | 4376.45 | 24984.61 | 0.0278 | — | — |
| 3 | 4385.04 | 24984.87 | 0.0274 | — | — |
| Mean | 4359.5 | 24977.63 | 0.028 | — | — |

The sample does not break even at the maximum charge that can be applied by the instrument

Specific Surface Area

| Temperature (° C.) | Specific surface area (m²/g) |
|---|---|
| 130 | 273 |
| 450 | 56 |
| 1000 | 5 |

The sintering is processed using the process described in example 1. The shrinkage is isotropic. A dimensional shrinkage, from composite part to ceramic, is of less than 0.001 percent.

The density of the obtained pieces is comprised between 6 and 6.1 g/cm³.

### EXAMPLE 3

Alcosol was prepared in a mixture of ethanol and water. Zirconium oxychloride (ZrOCl₂.8H₂O) was added to the mixture under stirring, and after oxalic acid (H₂C₂O₄) was also added slowly leading to zirconium sol formation. After that we introduced sodium hydroxide as a base until reaching a solution having a pH between 8 and 12. Afterward the produced powder was washed with an excess of water until neutralizing the pH of the solution. This powder was then dried under vacuum before heating it at 1000° C. for at least 2 hours.

Vinyl groups were grafted onto the surface of spherical particles in the same medium as precursors for polymerization compounding. 3-methacryloxypropyltrimethoxysilane (TPM) is used as a functionalized coupling agent, because it reacts easily with hydroxyl groups onto the zirconium oxide surface under mild conditions. A TPM was added to the mixture and stirred at room temperature. Then, a part of the solvent was removed by distillation under vacuum. The modified particles were extracted and dried under vacuum. Zirconium oxide/Yttrium oxide powder (97:3 in mol %) was dispersed in di-methacrylic monomers in the presence of the AIBN initiator (1 wt % of monomers weight). The composites were then compacted and shaped in a specific mold leading by in situ polymerization for a few minutes at a specific temperature to the final composite.

### EXAMPLE 4

Composites of doped zirconia/thermoplastic matrix can be also used as precursors for ceramics with a specific shape machined at the composite state. Zirconium oxide/yttrium oxide (97:3 and 92:8 mole percent), treated at 1000° C. for at least 2 hours, was dispersed in methyl methacrylate monomers (9.3 mole/l) in the presence of AIBN (2.2 mole/l) as the initiator. Then, the mixture was stirred for 1.7 hours under nitrogen atmosphere. The polymerization was carried out at 80° C. for 2 hours. The conversion of monomers is higher than 95% and under these conditions the molecular weight of synthesized polymer is about 67800 g/mole.

The obtained composites have a density in the range of about 2.4 g/cm³ to about 3.8 g/cm³.

### EXAMPLE 5

Composites of the doped zirconia/thermoplastic matrix can also be used as precursors for ceramics with a specific shape machined at the composite state. Zirconium oxide/yttrium oxide (97:3 and 92:8 mole percent), treated at 1000° C. for at least 2 hours, was dispersed in styrene monomers in the presence of AIBN as the initiator. The mixture was stirred for 2 hours under nitrogen atmosphere. The polymerization was carried out at 120° C. for 7 hours in the presence of nitroxide as the catalyst used for controlled free radical polymerization. The conversion of monomers is about 70%. The excess of monomers and free polymer chains was removed by repeated washing under filtration using toluene as a solvent. The composite was then dried at 120° C. under vacuum.

1. A method and a process for the preparation of ceramic precursors, which consists of composite bio-materials shaped using the CAD/CAM process and comprising:
a) One metal hydroxide spherical particle and/or a mixture of metal hydroxide spherical particles;
b) A covalent linker group on the surface of metal hydroxide spherical particles
c) A polymer and/or copolymer

2. Composite biomaterials as claimed in claim 1, wherein metal hydroxide particles are produced using a control process comprising:
a) An alcohol solvent, water-miscible solvent optional;
b) Water
c) An aqueous base catalyst
d) A metal alkoxide and/or a mixture of two metal alkoxides; or component precursors of metal hydroxides;

3. Composite biomaterials as claimed in claim 1, wherein metal alkoxides are zirconium alkoxide, aluminium alkoxide, titanium alkoxide. Silicon alkoxide and the like

4. Composite biomaterials as claimed in claim 1, wherein the component precursor of metal hydroxide is zirconium oxychloride.

5. Composite biomaterials as claimed in claim 1, wherein the surface of metal hydroxide particles is modified in their synthesis medium by introducing a covalent linker group

6. Composite biomaterials as claimed in claim 1, wherein the covalent linker groups are precursors for polymerization compounding;

7. Composite biomaterials as claimed in claim 1, wherein the composites are shaped using the CAD process before sintering to a ceramic piece.

8. Composite biomaterials as claimed in claim 1, wherein the composites are shaped by machining using CAD/CAM process before sintering to a ceramic piece.

9. Composite biomaterials as claimed in claim 1, wherein the said covalent linker groups are vinyl groups, initiators, amine molecules, carbonyl groups, polymerization catalyst and the like,

10. Composite biomaterials as claimed in claim 1, wherein the composites are prepared using polymerization compounding;

11. Composites biomaterials as claimed in claim 6, wherein the composites are prepared by free radical polymerization, living radical polymerization, polycondensation, and catalyst polymerization,

12. Composite biomaterials as claimed in claim 1, wherein the composites are prepared by polymerization in bulk, solution, emulsion, and dispersion medium;

13. Composite biomaterials as claimed in claim 1, wherein the polymer is a thermoplastic matrix, thermo-hardening matrix, rubber matrix.

14. Composite biomaterials as claimed in claim 1, wherein the copolymer matrix is a thermo-hardening matrix, thermoplastic-rubber matrix

15. Composite biomaterials as claimed in claim 1, wherein the composites are prepared by heating and light polymerization processes;

16. Composite biomaterials as claimed in claim 1, wherein the composites are shaped at the pressed state by in situ polymerization, by polymer melting;

17. Composite biomaterials as claimed in claim 1, wherein metal alkoxides are zirconium alkoxide, aluminium alkoxide, titanium alkoxide, silicon alkoxide and the like.

18. Composite biomaterials as claimed in claim 1, wherein the inorganic phase is zirconium oxide doped by metallic oxide.

19. Composite biomaterials as claimed in claim 1, wherein the metallic oxides are Yttrium oxide, Magnesium oxide, calcium oxide, cerium oxide and the like.

20. Composite biomaterials as claimed in claim 1, wherein the inorganic phase is doped by 3.0 to 15 mol % of metallic oxide.

21. Composite biomaterials as claimed in claim 1, wherein the composite is sintered at a temperature between 1300 and 1600° C.
